(19) United States
(12) Patent Application Publication
(10) Pub. No.: US 2019/0228410 A1
(43) Pub. Date: Jul. 25, 2019

(54) METHOD AND SYSTEM FOR GENERATING AND USING CONTEXTUAL CRYPTOGRAMS FOR PROXIMITY AND E-COMMERCE PAYMENT

(71) Applicant: Mastercard International Incorporated, Purchase, NY (US)

(72) Inventors: Arpit PATEL, Vadodara (IN); Gaurav DAYAL, Vadodara (IN); Hemal SHAH, Vadodara (IN)

(73) Assignee: Mastercard International Incorporated, Purchase, NY (US)

(21) Appl. No.: 15/878,608

(22) Filed: Jan. 24, 2018

(51) Int. Cl. G06Q 20/38; G06Q 20/12; G06Q 20/34; G06Q 20/40; G06F 17/30

(52) U.S. Cl. CPC G06Q 20/3829; G06Q 20/12; G06Q 20/341; H04W 12/12; G06Q 20/405; G06F 17/30864; G06Q 20/4014

(57) ABSTRACT

A method for processing contextual cryptograms includes: receiving, by a receiver of a processing server, transaction data for a proposed payment transaction; receiving, by the receiver of the processing server, at least one payment cryptogram and, for each payment cryptogram, an associated identifier; identifying, by the processing server, one or more contextual rules associated with each of the at least one payment cryptograms based on the respective associated identifier; determining, by the processing server, approval or denial of the proposed payment transaction based on the received transaction data as applied to each of the identified one or more contextual rules for each of the at least one payment cryptograms; and transmitting, by a transmitter of the processing server, the determined approval or denial of the proposed payment transaction.

### FIELD

The present disclosure relates to the use of contextual cryptograms in payment transactions, specifically the use of cryptograms that are subject to contextual rules on usage thereof in a payment transaction where payment transactions are denied if a cryptogram is used in a manner that does not satisfy its contextual rules.

### BACKGROUND

Consumers conduct payment transactions using credit cards, debit cards, virtual cards, and other electronic payment instruments for a variety of reasons. One benefit of these types of payment instruments is the ability to have transaction controls associated therewith. Transaction controls are limitations placed on the usage of a transaction account, where a payment transaction attempted using a payment instrument associated with that transaction must comply with the transaction controls or be denied. Additional information regarding transaction controls and use thereof can be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. Pat. No. 7,359,880, issued Apr. 15, 2008; U.S. Pat. No. 7,895,122, issued Feb. 22, 2011; U.S. Pat. No. 8,229,854, issued Jul. 27, 2012; U.S. Pat. No. 8,321,315, issued Nov. 27, 2012; U.S. Pat. No. 8,510,218, issued Aug. 13, 2013; U.S. Pat. No. 8,639,623, issued Dec. 27, 2012; U.S. Pat. No. 8,756,150, issued Jun. 17, 2014; and U.S. Pat. No. 8,527,416, issued Sep. 3, 2013, each of which are herein incorporated by reference in their entirety.

However, transaction controls are associated with transaction account numbers, either the primary account number associated with the transaction account or a controlled payment number or other number that is associated with the transaction account but may not be primary. With the rise of electronic wallets, smart watches, and other devices that can be adapted for use in conveying payment credentials, tokenization has become prevalent for electronic payment transactions, where a primary account number or other payment instrument is tokenized to increase account security. In such cases, the transaction controls are associated with the original number, and not the associated token. As a result, an additional step is required in the processing of such transactions as the original account number must be identified prior to the application of transaction controls, which reduces the speed at which a transaction may be processed and can limit, if not prohibit entirely, the use of on-behalf processing for issuing institutions.

Thus, there is a need for a technological solution to enable transaction controls to be set for a transaction account that are associated with payment credential information other than an account number while still enabling the use of transaction controls that can be assigned on a per-instrument basis.

### SUMMARY

The present disclosure provides a description of systems and methods for processing cryptograms that are subject to contextual rules. Contextual rules, which restrict the use of a cryptogram to specific transactions that comply with the rules, are set on a per-cryptogram basis, where a single payment instrument may have multiple payment cryptograms associated therewith for use in a payment transaction. Each cryptogram may be used in a specific type of payment transactions (e.g., one cryptogram for restaurants, one cryptogram for clothing stores, one cryptogram for automated teller machine transactions, etc.) such that the contextual rules will accordingly only apply to those types of transactions. By utilizing cryptograms, which payment cards and other payment instruments are already configured to generate, contextual rules may be used for a transaction account without requiring the issuing of controlled payment numbers for that account, which saves convenience for users who don't need to keep track of a large number of account numbers, as well as for issuing institutions that do not need to update their systems to handle mapping and multiple account numbers for a single transaction account. Thus, contextual rules for cryptograms as discussed herein can provide a number of benefits while minimizing the negative impact on each party involved in payment transactions.

A method for processing contextual cryptograms includes: receiving, by a receiver of a processing server, transaction data for a proposed payment transaction; receiving, by the receiver of the processing server, at least one payment cryptogram and, for each payment cryptogram, an associated identifier; identifying, by the processing server, one or more contextual rules associated with each of the at least one payment cryptograms based on the respective associated identifier; determining, by the processing server, approval or denial of the proposed payment transaction based on the received transaction data as applied to each of the identified one or more contextual rules for each of the at least one payment cryptograms; and transmitting, by a transmitter of the processing server, the determined approval or denial of the proposed payment transaction.

A system for processing contextual cryptograms includes: a transmitter of a processing server; and a receiver of the processing server configured to receive transaction data for a proposed payment transaction, and at least one payment cryptogram and, for each payment cryptogram, an associated identifier, wherein the processing server is configured to identify one or more contextual rules associated with each of the at least one payment cryptograms based on the respective associated identifier, and determine approval or denial of the proposed payment transaction based on the received transaction data as applied to each of the identified one or more contextual rules for each of the at least one payment cryptograms, and the transmitter of the processing server is configured to electronically transmit the determined approval or denial of the proposed payment transaction.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for processing contextual cryptograms in a payment transaction in accordance with exemplary embodiments.

FIG. 2 is a block diagram illustrating the processing server of the system of FIG. 1 for processing contextual cryptograms in accordance with exemplary embodiments.

FIG. 3 is a flow diagram illustrating a process for the processing of contextual cryptograms executed by the processing server of FIG. 2 in accordance with exemplary embodiments.

FIG. 4 is a flow chart illustrating an exemplary method for processing contextual cryptograms in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Point of Sale—A computing device or computing system configured to receive interaction with a user (e.g., a consumer, employee, etc.) for entering in transaction data, payment data, and/or other suitable types of data for the purchase of and/or payment for goods and/or services. The point of sale may be a physical device (e.g., a cash register, kiosk, desktop computer, smart phone, tablet computer, etc.) in a physical location that a customer visits as part of the transaction, such as in a “brick and mortar” store, or may be virtual in e-commerce environments, such as online retailers receiving communications from customers over a network such as the Internet. In instances where the point of sale may be virtual, the computing device operated by the user to initiate the transaction or the computing system that receives data as a result of the transaction may be considered the point of sale, as applicable.

### System for Processing of Contextual Cryptograms

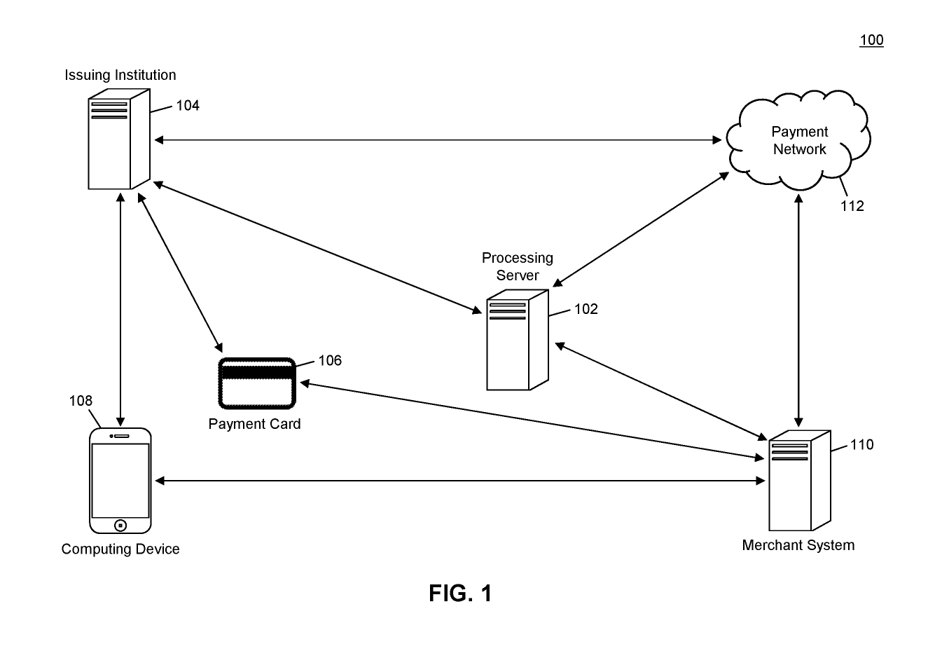

FIG. 1 illustrates a system 100 for the processing of payment transactions that utilize cryptograms that are subject to contextual rules that affect the authorization of the payment transaction based on, in part, transaction data for the payment transaction.

The system 100 may include a processing server 102. The processing server 102, discussed in more detail below, may be configured to process contextual cryptograms are part of the authorization process for an electronic payment transaction. In the system 100, an issuing institution 104 may issue a transaction account that can be used to fund an electronic payment transaction. The issuing institution 104 may be a financial institution, such as an issuing bank, or other suitable type of entity configured to issue transaction accounts that may be used to fund electronic payment transactions. The issuing institution 104 may issue a transaction account to a user as well as issuing a payment card 106 or other payment instrument thereto. The payment card 106 may be configured to store, generate, or otherwise have access to payment credentials that may be used to convey details associated with the transaction account that are necessary to ensure that a payment transaction is funded by the corresponding transaction account. In some embodiments, a computing device 108 may operate as the payment instrument for a transaction account. In such embodiments, payment credentials may be provisioned to the computing device 108, such as via an electronic wallet application program stored therein or otherwise executed thereby. The computing device 108 may be any suitable type of computing device, such as a cellular phone, smart phone, smart watch, wearable computing device, implantable computing device, tablet computer, notebook computer, laptop computer, desktop computer, smart television, etc.

In the system 100, an electronic payment transaction may be conducted by an individual authorized to utilize the transaction account and a merchant, represented in FIG. 1 by the merchant system 110. The merchant system 110 may be or include a point of sale system or other computing system that may be utilized by the merchant in the collection of payment credentials from the payment card 106 or computing device 108 for submission as part of the authorization process for an electronic payment transaction. The individual may present the payment card 106 or computing device 108, as applicable, to convey the payment credentials to the merchant system 110. Payment credentials may be conveyed using any suitable method, such as by the merchant system 110 reading the details encoded in a magnetic strip of the payment card 106, receiving the payment credentials from an integrated circuit of the payment card 106, receiving the payment credentials via near field communication from the payment card 106 or computing device 108, decoding a machine-readable code displayed by the computing device 108, etc.

The payment credentials may include any data necessary for use in processing an electronic payment transaction that is funded by the corresponding transaction account. Such data may include a primary account number, name, expiration date, security code, application transaction counters, or any other data that will be apparent to persons having skill in the relevant art. In addition to such data, the payment credentials may include at least one payment cryptogram. A payment cryptogram may be a unique value that is generated at the time of or prior to a payment transaction using a predetermined method, which may utilize additional data to ensure uniqueness of the cryptogram, that may be independently generated by other parties in a transaction, such as the issuing institution 104 or merchant system 110. Independent generation of the cryptogram may be used such that, if the cryptograms match, the payment instrument may be determined to be authentic or otherwise uncompromised and the payment transaction processed accordingly. In the system 100, the payment card 106 or computing device 108, as applicable, may be configured to use a plurality of different payment cryptograms.

As part of the issuing and management of the transaction account, the issuing institution 104 may enable an authorized user to register the transaction account to utilize a plurality of different payment cryptograms. Each of the payment cryptograms may be associated with at least one type of payment transaction, where the type may be based on any potential criteria that may be useful to the authorized user. The payment cryptogram may be used only for the associated types of payment transactions, where only the appropriate payment cryptogram may be supplied to a merchant system 110 based on the satisfaction of the proposed payment transaction to the applicable criteria. Such criteria may include, for example, merchant category code, geographic location, transaction time, transaction date, day of the week, month, product category, transaction amount, merchant identity, product identity, etc., or a combination thereof. For instance, a transaction account may have a first payment cryptogram applicable for all electronics merchants, a second payment cryptogram applicable for all merchants in a specific geographic area, and a third payment cryptogram applicable for all other transactions. In some cases, multiple payment cryptograms may be applicable for a payment transaction. In some such cases, each of the payment cryptograms may be applied. In other such cases, a priority system may be established to identify which payment cryptogram to utilize, where the priority may be set by the authorized user, issuing institution 104, processing server 102, merchant system 110, or other entity.

Each of the payment cryptograms may be subject to one or more contextual rules. A contextual rule may be a rule that is applicable to a proposed electronic payment transaction where the transaction must comply with that rule in order for the transaction to be authorized (e.g., subject to other authorizations, rules, and determinations). The contextual rule may be any type of transaction control or limit that may be based on any data associated with a payment transaction, as well as potentially being based on additional data, such as historical transaction data for the transaction account. For example, a first contextual rule may be that no transactions above $50 are allowed for the applicable types of payment transactions, while a second contextual rule may be that additional authentication information must be collected for the payment transaction. A third contextual rule may be that only specific identified merchants are allowed to be transacted with by the transaction account. The contextual rules may be set by an authorized user of the transaction account using any suitable method, such as an application program or web page accessible via the computing device 108. In some embodiments, the establishing of contextual rules and additional payment cryptograms may be performed by the issuing institution 104 or the processing server 102. In some cases, the processing server 102 may be a part of the issuing institution 104.

As part of the conveying of payment details to the merchant system 110, at least one payment cryptogram may be provided to the merchant system 110. In some embodiments, the computing device 108 or payment card 108 may be configured to determine what cryptogram(s) is/are applicable to the proposed payment transaction. In other embodiments, the authorized user may select the applicable payment cryptogram, such as through a graphical user interface provided by the computing device 108 or payment card 106. In still other embodiments, all payment cryptograms may be conveyed to the merchant system 110, where the merchant system 110 may be configured to identify the applicable payment cryptogram, such as based on transaction data stored therein. The merchant system 110 may thus receive the payment credentials including the applicable payment cryptogram(s).

Prior to submission of the payment transaction for processing, or as part of the authorization processing of the payment transaction, the processing server 102 may determine if the contextual rules that are set for the applied payment cryptogram(s) are complied with by the payment transaction. In some embodiments, the processing server 102 may be a part of the merchant system 110 and may receive the payment cryptogram(s), transaction data, and any other data used in the performing of the functions discussed herein via internal communication. For instance, in some cases, the processing server 102 may a part of the point of sale device used in the transaction for the merchant system 110, or the point of sale device may be otherwise configured to perform functions of the processing server 102 as discussed herein. In other embodiments, the processing server 102 may be external to the merchant system 110, where the merchant system 110 may electronically transmit the payment cryptogram(s) and any other applicable data to the processing server 102.

The processing server 102 may be configured to identify the contextual rules for each received payment cryptogram. In some embodiments, the contextual rules may be supplied by the payment instrument to the merchant system 110, and may accompany the associated payment cryptogram. In other embodiments, the processing server 102 may be configured to identify the contextual rules for a payment cryptogram. In one such embodiment, the processing server 102 may request the contextual rules from the issuing institution 104. In another such embodiment, when contextual rules are set for a payment cryptogram, the issuing institution 104 may register those contextual rules with the processing server 102. In some embodiments, each payment cryptogram may have an identifier associated therewith. The identifier may be a value that is associated with the payment cryptogram that may be used to identify the contextual rules applicable for that payment cryptogram. In some cases, the value may be unique to the payment cryptogram. In other cases, the value may be unique to a set of contextual rules (e.g., where multiple cryptograms may utilize such rules and thus have the same identifier, which may change if the rules for a particular cryptogram are changed). In these embodiments, the identifier may be used by the processing server 102 in identifying the applicable set of contextual rules, such as through querying of internal or externally-accessible memory or through inquiry with the issuing institution 104. The identifier may be any suitable type of value. In some instances, the identifier may be a portion of the payment cryptogram itself or data used in the generation of the payment cryptogram.

Once the processing server 102 has identified one or more contextual rules that are associated with a payment cryptogram applicable in the transaction, the processing server 102 may determine if the contextual rules are satisfied by the payment transaction. In some cases, the processing server 102 may supply the contextual rules to the merchant system 110 or issuing institution 104 for the determination. The determination may be based on application of the contextual rules to the transaction data for the payment transaction to determine compliance thereto. Transaction data may include, for instance, transaction amount, transaction time, transaction date, currency type, transaction type, merchant identifier, merchant category code, product identifier, product category, geographic location, coupon data, offer data, reward data, loyalty data, etc. For example, if a contextual rule limits payment transactions to $50, the processing server 102 may identify the transaction amount for the payment transaction where any transaction amount above $50 may result in a determination of non-compliance. In cases where the contextual rule may be based on multiple payment transactions, the processing server 102 may be configured to identify such data accordingly, such as through internal querying (e.g., if the processing server 102 stores historical transaction data) or by requesting such data from the appropriate issuing institution 104.

Once the determination has been made, the processing server 102 may return the determination to the appropriate entity, such as the merchant system 110 or issuing institution 104. In some embodiments, a negative determination (e.g., the transaction does not comply with the contextual rules) may result in immediate denial of the payment transaction. For instance, the processing server 102 may be requested to process the contextual rules by the merchant system 110 prior to submission of the payment transaction for authorization. In such an instance, if the determination is negative, the merchant system 110 may immediately deny the payment transaction. In other embodiments, authorization of the payment transaction may still be attempted, but where the transaction data may include or be accompanied by the negative determination, or where the processing server 102 may provide the negative determination to the issuing institution 104.

Authorization of the payment transaction may be performed using traditional methods and systems, in combination with the determination of the satisfaction of the contextual rules as performed by the processing server 102. In a traditional authorization, the merchant system 110 may submit the transaction data to a payment network 112 for processing, either directly via payment rails associated with the payment network 112 or through one or more intermediate entities, such as an acquiring financial institution that issues a transaction account to the merchant for use in receiving the funds for the payment transaction. The payment network 112 may receive the transaction data, which may be included in a transaction message, which may be a specially formatted type of data message that is electronically transmitted through the payment rails associated with the payment network 112. For instance, transaction messages may be compliant with one or more standards governing the interchange of financial transaction messages, such as the International Organization of Standardization's ISO 8583 or ISO 20022 standards. The payment network 112 may receive the transaction message, which may be an authorization request, and may process the transaction message accordingly. In some cases, the payment network 112 may perform value-added services for the payment transaction, such as fraud scoring, risk determinations, de-tokenization, etc.

The transaction message may be provided to the issuing institution 104, which may determine approval or denial of the payment transaction using traditional methods, such as basing approval on the amount of the payment transaction and available credit in the applicable transaction account. Approval or denial may be further based on validation of the payment cryptograms, which may be unrelated to the contextual rules and may be performed using traditional cryptogram validation processes. For instance, the issuing institution 104 may generate its own versions of the applicable payment cryptogram(s), which may be compared to the payment cryptograms included in the transaction message (e.g., as provided by the payment instrument) for validation thereof. The approval or denial of the payment transaction may be returned to the payment network 112 in the same or a different transaction message, which may be an authorization response. The payment network 112 may perform any additional necessary services and return the authorization response to the merchant system 110 (e.g., through any intermediate entities, such as an acquirer). The merchant system 110 may then finalize the payment transaction based on the approval or denial.

In the system 100, the issuing institution 104, payment network 112, or merchant system 110 may request the processing of the contextual cryptograms by the processing server 102 at any stage of the authorization process for the payment transaction. In such cases, the requesting entity may be configured to maintain the processing of the payment transaction or may terminate the processing based on the determination provided by the processing server 102. For instance, the payment network 112 may request the processing of the contextual rules for the applicable payment cryptograms after receiving the authorization request from the merchant system 110, where the payment network 112 may immediately return an authorization response indicating that the payment transaction is denied to the merchant system 110 if the processing server 102 determines that the payment transaction is non-compliant with the contextual rules for the applicable payment cryptograms. In cases where historical transaction data may be used in determining compliance with contextual rules, the processing server 102 may be configured to store transaction data for the payment transaction, which may be directly associated with the applicable cryptogram (e.g., via the associated identifier) or the transaction account used in the payment transaction. In some such cases, transaction data may only be stored for approved payment transactions. In these cases, the merchant system 110, payment network 112, or issuing institution 104 may inform the processing server 102 of approval of the payment transaction, and, in some instances, may provide the transaction data for storage with the approval.

The methods and systems discussed herein enable payment transactions to be controlled and limited on a per-cryptogram basis for a transaction account and, more particularly, payment instrument issued on that transaction account. By utilizing contextual rules, an authorized user of a transaction account may be able to control what types of transactions may be allowed, with different rules being applied to transactions based on which cryptogram is applicable for a transaction, which itself may be controlled based on transaction criteria. As the rules are applied on a per-cryptogram basis, the system 100 may be implemented with little to no modification to merchant systems 110, issuing institutions 104, and payment networks 112 through the specialized functions provided by the specifically configured processing server 102. The result is a system that provides beneficial controls to account holders that can benefit issuing institutions 104, without requiring the issuing of multiple account numbers, payment instruments, or changes to issuing institution systems.

### Processing Server

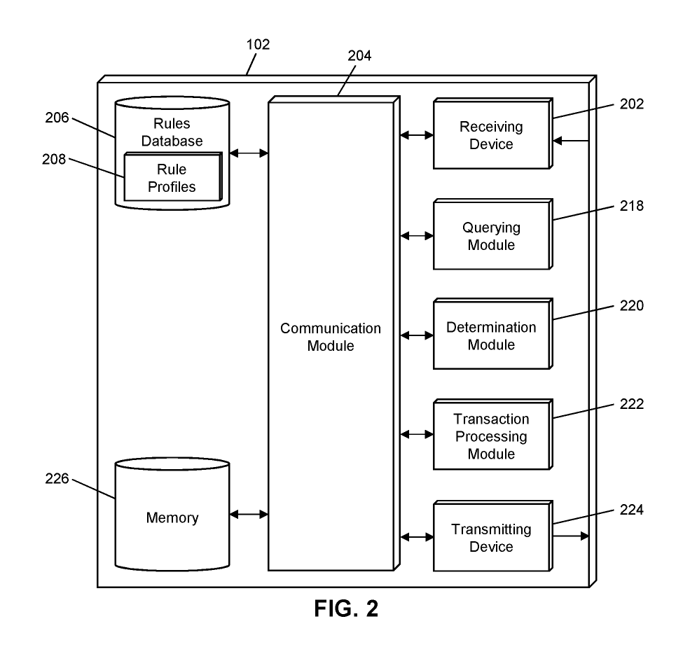

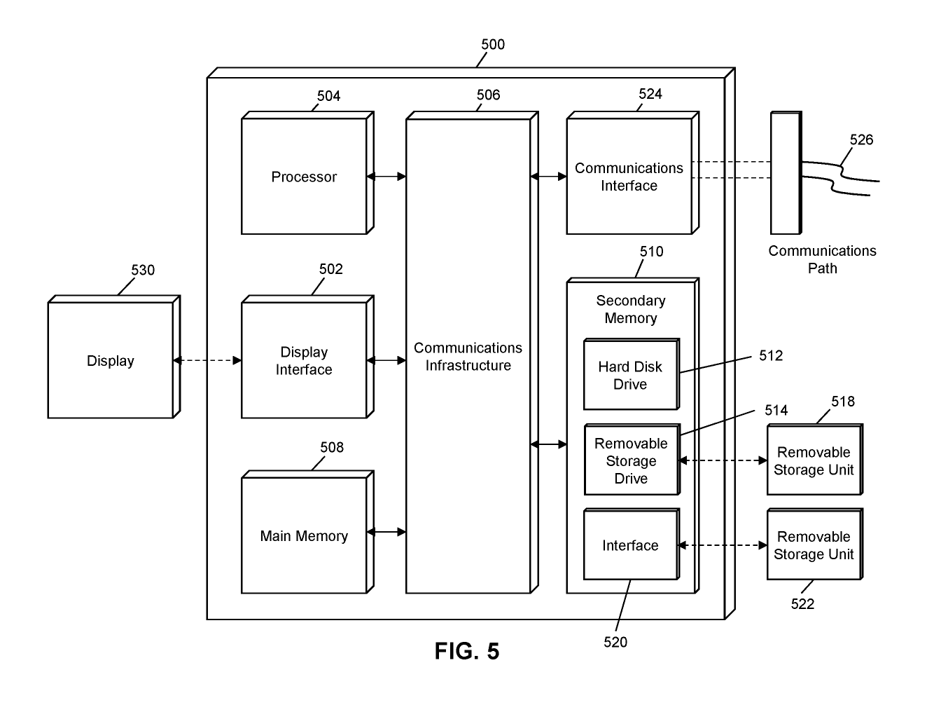

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from issuing institutions 104, merchant systems 110, payment networks 112, computing devices 108, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by issuing institutions 104, merchant systems 110, payment networks 112, or, in some instances, directly from payment instruments, which may be superimposed or otherwise encoded with a payment cryptogram, which may include or be accompanied with an associated identifier. The payment cryptogram may also be accompanied by, or the receiving device 202 may separately receive, transaction data for a payment transaction in which the payment cryptogram is to be used. The receiving device 202 may also be configured to receive data signals superimposed or otherwise encoded with contextual rules, which may be electronically transmitted by the issuing institution 104, merchant system 110, or a payment instrument. The receiving device 202 may also be configured to receive data signals electronically transmitted by issuing institutions 104 or payment networks 112, which may be superimposed or otherwise encoded with transaction data for an approved and processed payment transaction. The receiving device 202 may also be configured to receive data signals electronically transmitted by computing devices 108, which may be superimposed or otherwise encoded with instructions for the establishing of payment cryptograms and/or contextual rules as well as the management thereof.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, determination module 220, transaction processing module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

In some embodiments, the processing server 102 may include a rules database 206. The rules database 206 may be configured to store a plurality of rule profiles 208 using a suitable data storage format and schema. The rules database 206 may be a relational database that utilizes structured query language for the storage, identification, modifying, updating, accessing, etc. of structured data sets stored therein. Each rule profile 208 may be a structured data set configured to store data related to a payment cryptogram, and may include at least the associated identifier for the related payment cryptogram and the one or more contextual rules applicable thereto. In some cases, the rule profile 208 may also store historical transaction data that may be used when determining compliance with applicable contextual rules. In some instances, a single rule profile 208 may be used to store the contextual rules and cryptogram identifiers for all payment cryptograms associated with a single transaction account. In such instances, the rule profile 208 may also include information identifying the transaction account, such as a primary account number.

The processing server 102 may include a querying module 218. The querying module 218 may be configured to execute queries on databases to identify information. The querying module 218 may receive one or more data values or query strings, and may execute a query string based thereon on an indicated database, such as the rules database 206, to identify information stored therein. The querying module 218 may then output the identified information to an appropriate engine or module of the processing server 102 as necessary. The querying module 218 may, for example, execute a query on the rules database 206 to identify the contextual rules that are applicable to a payment cryptogram in a proposed payment transaction based on the associated identifier included therein as may be identified in transaction data supplied to the processing server 102 (e.g., received via the receiving device 202). The querying module 218 may also be configured to execute queries on the rules database 206 to modify the contextual rules and/or payment cryptogram data (e.g., applicability criteria) in a rule profile 208, such as via part of the management of payment cryptograms and contextual rules for the processing server 102 at the request of an authorized user.

The processing server 102 may also include a determination module 220. The determination module 220 may be configured to make determinations for the processing server 102 in accordance with the functions discussed herein. The determination module 220 may receive instructions as input, may make a determination as instructed, and may output a result of the determination to another module or engine of the processing server 102. In some cases, the input may include data for use in the determination. In other cases, the determination module 220 may be configured to identify such data as may be used in the determination. The determination module 220 may, for example, be configured to determine compliance of a payment transaction with one or more contextual rules, based on the rules and transaction data for the payment transaction. In some cases, the determination module 220 may be configured to determine approval or denial of the payment transaction itself based on its determination of compliance with contextual rules.

The processing server 102 may also include a transaction processing module 222. The transaction processing module 222 may be configured to perform functions associated with the processing of transactions as part of the processing server 102 as discussed herein. For example, the transaction processing module 222 may be configured to perform mapping, tokenization or de-tokenization, risk scoring, fraud detection, currency conversion, cryptogram validation, or other functions related to the processing of payment transactions. In some instances, the functions performed by the transaction processing module 222 may be based on the location of the processing server 102 (e.g., the functions may differ if the processing server 102 is part of the issuing institution 104 as opposed to the merchant system 110) as well as the stage in the authorization process where the processing server 102 is utilized (e.g., pre-submission of the transaction message, prior to approval by the issuing institution 104, after approval by the issuing institution 104, etc.).

The processing server 102 may also include a transmitting device 224. The transmitting device 224 may be configured to transmit data over one or more networks via one or more network protocols. In some instances, the transmitting device 224 may be configured to transmit data to issuing institutions 104, merchant systems 110, payment networks 112, computing devices 108, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to issuing institutions 104, merchant systems 110, and payment networks 112 that may be superimposed or otherwise encoded with determination results related to determinations of compliance or non-compliance or determinations of approval or denial of a payment transaction based on the satisfaction of contextual rules or payment cryptograms applicable to the payment transaction. In some embodiments, the transmitting device 224 may be configured to transmit data signals to issuing institutions 104 that are superimposed or otherwise encoded with requests for contextual rules, such as in cases where the issuing institution 104 may manage payment cryptograms and their contextual rules for its issued transaction accounts. In some cases, the transmitting device 224 may be configured to electronically transmit data signals to computing devices 108, which may be superimposed or otherwise encoded with messages related to the management or applicability of contextual rules. For instance, the transmitting device 224 may transmit notifications to the computing device 108 if a payment transaction is denied for non-compliance with contextual rules.

The processing server 102 may also include a memory 226. The memory 226 may be configured to store data for use by the processing server 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store, for example, historical transaction data, cryptogram generation algorithms, applicability criteria, etc.

### Process For Transaction Determinations For Contextual Cryptograms

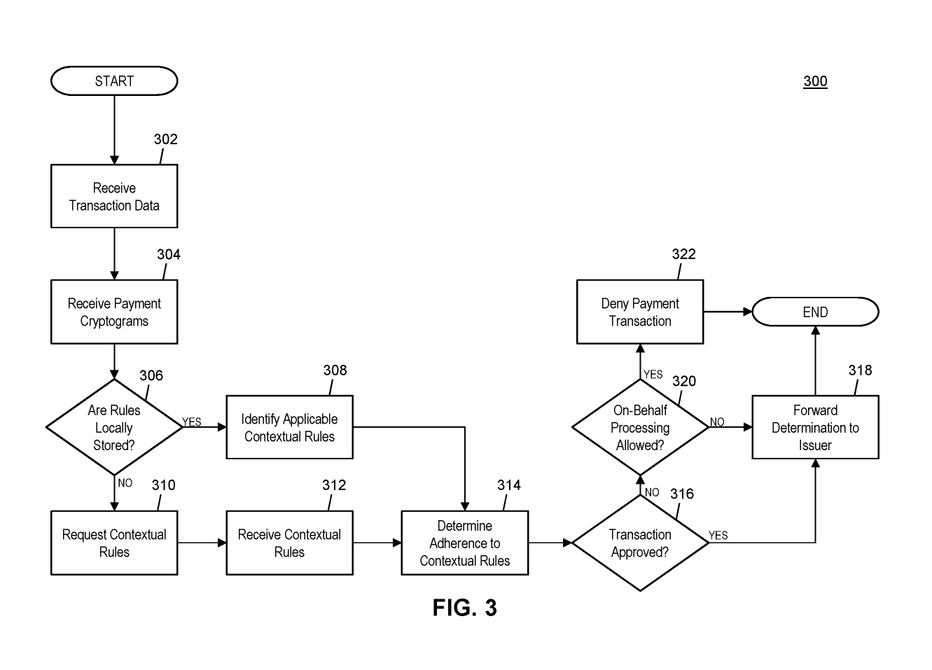

FIG. 3 illustrates an example process executed by the processing server 102 of FIG. 2 in the system 100 of FIG. 1 for the processing of a payment transaction based on contextual rules that are applicable to a payment cryptogram used in the payment transaction based on criteria thereof.

In step 302, the receiving device 202 of the processing server 102 may receive transaction data. The transaction data may be received from a merchant system 110, payment network 112, issuing institution 104, or may be received via one or more input devices interfaced with the processing server 102, such as in instances where the processing server 102 may be part of a point of sale system at a merchant. In step 304, the receiving device 202 of the processing server 102 may receive one or more payment cryptograms presented with payment credentials for use in a proposed payment transaction. In some embodiments, payment cryptograms may be received from the merchant system 110, payment network 112, or issuing institution 104, or may be received directly from a payment instrument (e.g., the payment card 106 or computing device 108). In some instances, steps 302 and 304 may be performed at the same time or in a single action (e.g., the payment cryptograms and transaction data may be received together, such as in a single transaction message).

In step 306, the processing server 102 may determine of contextual rules are locally available. The determination may be based on the existence of a rules database 206 in the processing server 102 and if a rule profile 208 is stored therein that includes an associated identifier for each received payment cryptogram. If rule profiles 208 do exist for the payment cryptograms received for the payment transaction, then, in step 308, the querying module 218 of the processing server 102 may execute a query on the rules database 206 to identify the rule profiles 208 and the contextual rules included therein. If rule profiles 208 do not exist, then, in step 310, the transmitting device 224 of the processing server 102 may electronically transmit a data request to the issuing institution 104 that includes the associated identifiers for each payment cryptogram and requests the contextual rules associated therewith. In step 312, the receiving device 202 of the processing server 102 may receive the contextual rules from the issuing institution 104. In some embodiments, the querying module 218 of the processing server 102 may execute a query on the rules database 206 to insert a new rule profile 208 for each payment cryptogram that includes its associated identifier and the contextual rules received for the respective cryptogram.

In step 314, the determination module 220 of the processing server 102 may determine if the payment transaction adheres to the contextual rules that are associated with each of the payment cryptograms applied to the payment transaction. The determination may be based on at least the received transaction data and each of the contextual rules, and may, in some cases, also be based on historical transaction data associated with the transaction account or each respective payment cryptogram. The determination may return a positive or negative result depending on if the contextual rules are complied with or not, respectively, by the payment transaction. In step 316, the determination module 220 of the processing server 102 may determine if the transaction should be approved or not, based on the determination with respect to the contextual cryptograms (e.g., and any other factors that may be applicable to payment transactions as will be apparent to persons having skill in the relevant art).

If the processing server 102 determines that the payment transaction is approved, then, in step 318, the transmitting device 224 of the processing server 102 may electronically transmit a notification to the issuing institution 104 that the determination was successful and that the payment transaction is recommended for approval. In cases where a transaction message was received by the processing server 102 in step 302, the determination may be stored in the transaction message, which may be forwarded on to the issuing institution 104. If the processing server 102 determines that the payment transaction is not approved, then, in step 320, the processing server 102 may identify if the processing server 102 is authorized by the issuing institution 104 to perform on-behalf processing. If on-behalf processing is not allowed, then the process 300 may proceed to step 318 where a determination may be electronically transmitted to the issuing institution 104 by the transmitting device 224 of the processing server 102, which may indicate that the transaction should be denied for non-compliance with the contextual rules. If on-behalf processing is allowed, then, in step 322, the transaction processing module 222 of the processing server 102 may deny the payment transaction, which may include generating an authorization response for the payment transaction that includes a response code indicating denial of the payment transaction, which may then be forwarded by the transmitting device 224 of the processing server 102 to the appropriate entity.

### Exemplary Method for Processing Contextual Cryptograms

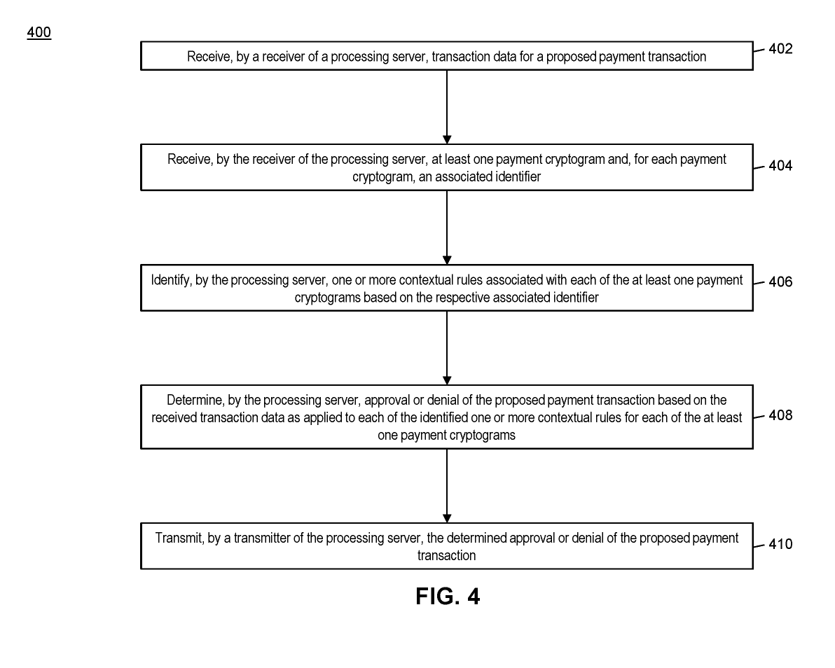

FIG. 4 illustrates a method 400 for the processing of payment transactions using contextual rules associated with one or more payment cryptograms that are applicable to the payment transaction.

In step 402, transaction data for a proposed payment transaction may be received by a receiver (e.g., the receiving device 202) of a processing server (e.g., the processing server 102). In step 404, at least one payment cryptogram may be received by the receiver of the processing server and, for each payment cryptogram, an associated identifier. In step 406, one or more contextual rules associated with each of the at least one payment cryptograms may be identified by the processing server based on the respective associated identifier.

In step 408, approval or denial of the payment transaction may be determined by the processing server based on the received transaction data as applied to each of the identified one or more contextual rules for each of the at least one payment cryptograms. In step 410, the determined approval or denial of the proposed payment transaction may be transmitted by a transmitter (e.g., the transmitting device 224) of the processing server.

In one embodiment, the associated identifier for each at least one payment cryptogram may be included in the respective cryptogram. In some embodiments, the at least one payment cryptogram may be received from a mobile computing device (e.g., the computing device 108) or integrated circuit card (e.g., the payment card 106), and the determined approval or denial of the payment transaction may be transmitted to an issuing financial institution (e.g., the issuing institution 104) associated with a transaction account corresponding to the at least one payment cryptogram. In a further embodiment, the determined approval or denial may be transmitted to the issuing financial institution if the determination is approval, and the determined approval or denial may be transmitted to one of: the mobile computing device or a display device if the determination is denial. In one embodiment, the method 400 may further include generating, by the processing server, a verification cryptogram for each of the received at least one payment cryptograms, wherein determination of approval or denial of the proposed payment transaction is further based on a comparison of each generated verification cryptogram to the respective payment cryptogram.

In some embodiments, the method 400 may also include storing, in a rules database (e.g., the rules database 206) of the processing server, a plurality of rule profiles (e.g., rule profiles 208), wherein each rule profile includes at least a cryptogram identifier and one or more contextual rules associated with the included cryptogram identifier, wherein identifying the one or more contextual rules includes executing, by the processing server, a query on the rules database to identify, for each of the at least one payment cryptograms, the one or more contextual rules included in a rule profile where the included cryptogram identifier matches the associated identifier. In one embodiment, identifying the one or more contextual rules may comprise: electronically transmitting, by the transmitter of the processing server, the associated identifier for each of the at least one payment cryptograms to an external system; and receiving, by the receiver of the processing server, the one or more contextual rules associated with each of the at least one payment cryptograms. In some embodiments, each of the one or more contextual rules may specify a threshold or limitation on one or more transaction data values, and the determined approval or denial of the proposed payment transaction may be further based on a value for each of the one or more transaction data values specified by each of the one or more contextual rules included in the transaction data as compared to the respective threshold or limitation.

### Computer System Architecture

FIG. 5 illustrates a computer system 500 in which embodiments of the present disclosure, or portions thereof, may be implemented as computer-readable code. For example, the processing server 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for guaranteeing a blockchain transaction via an alternative payment network. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for processing contextual cryptograms, comprising:
receiving, by a receiver of a processing server, transaction data for a proposed payment transaction;
receiving, by the receiver of the processing server, at least one payment cryptogram and, for each payment cryptogram, an associated identifier;
identifying, by the processing server, one or more contextual rules associated with each of the at least one payment cryptograms based on the respective associated identifier;
determining, by the processing server, approval or denial of the proposed payment transaction based on the received transaction data as applied to each of the identified one or more contextual rules for each of the at least one payment cryptograms; and
transmitting, by a transmitter of the processing server, the determined approval or denial of the proposed payment transaction.

2. The method of claim 1, wherein the associated identifier for each at least one payment cryptogram is included in the respective cryptogram.

3. The method of claim 1, wherein
the at least one payment cryptogram is received from a mobile computing device or integrated circuit card, and
the determined approval or denial of the payment transaction is transmitted to an issuing financial institution associated with a transaction account corresponding to the at least one payment cryptogram.

4. The method of claim 3, wherein
the determined approval or denial is transmitted to the issuing financial institution if the determination is approval, and
the determined approval or denial is transmitted to one of: the mobile computing device or a display device if the determination is denial.

5. The method of claim 1, further comprising:
generating, by the processing server, a verification cryptogram for each of the received at least one payment cryptograms, wherein
determination of approval or denial of the proposed payment transaction is further based on a comparison of each generated verification cryptogram to the respective payment cryptogram.

6. The method of claim 1, further comprising:
storing, in a rules database of the processing server, a plurality of rule profiles, wherein each rule profile includes at least a cryptogram identifier and one or more contextual rules associated with the included cryptogram identifier, wherein
identifying the one or more contextual rules includes executing, by the processing server, a query on the rules database to identify, for each of the at least one payment cryptograms, the one or more contextual rules included in a rule profile where the included cryptogram identifier matches the associated identifier.

7. The method of claim 1, wherein identifying the one or more contextual rules comprises:
electronically transmitting, by the transmitter of the processing server, the associated identifier for each of the at least one payment cryptograms to an external system; and
receiving, by the receiver of the processing server, the one or more contextual rules associated with each of the at least one payment cryptograms.

8. The method of claim 1, wherein
each of the one or more contextual rules specifies a threshold or limitation on one or more transaction data values, and
the determined approval or denial of the proposed payment transaction is further based on a value for each of the one or more transaction data values specified by each of the one or more contextual rules included in the transaction data as compared to the respective threshold or limitation.

9. A system for processing contextual cryptograms, comprising:
a transmitter of a processing server; and
a receiver of the processing server configured to receive transaction data for a proposed payment transaction, and
at least one payment cryptogram and, for each payment cryptogram, an associated identifier, wherein
the processing server is configured to
identify one or more contextual rules associated with each of the at least one payment cryptograms based on the respective associated identifier, and
determine approval or denial of the proposed payment transaction based on the received transaction data as applied to each of the identified one or more contextual rules for each of the at least one payment cryptograms, and
the transmitter of the processing server is configured to electronically transmit the determined approval or denial of the proposed payment transaction.

10. The system of claim 9, wherein the associated identifier for each at least one payment cryptogram is included in the respective cryptogram.

11. The system of claim 9, wherein
the at least one payment cryptogram is received from a mobile computing device or integrated circuit card, and
the determined approval or denial of the payment transaction is transmitted to an issuing financial institution associated with a transaction account corresponding to the at least one payment cryptogram.

12. The system of claim 11, wherein
the determined approval or denial is transmitted to the issuing financial institution if the determination is approval, and
the determined approval or denial is transmitted to one of: the mobile computing device or a display device if the determination is denial.

13. The system of claim 9, wherein
the processing server is further configured to generate a verification cryptogram for each of the received at least one payment cryptograms, and
determination of approval or denial of the proposed payment transaction is further based on a comparison of each generated verification cryptogram to the respective payment cryptogram.

14. The system of claim 9, further comprising:
a rules database of the processing server configured to store a plurality of rule profiles, wherein each rule profile includes at least a cryptogram identifier and one or more contextual rules associated with the included cryptogram identifier, wherein
identifying the one or more contextual rules includes executing, by the processing server, a query on the rules database to identify, for each of the at least one payment cryptograms, the one or more contextual rules included in a rule profile where the included cryptogram identifier matches the associated identifier.

15. The system of claim 9, wherein identifying the one or more contextual rules comprises:
electronically transmitting, by the transmitter of the processing server, the associated identifier for each of the at least one payment cryptograms to an external system; and
receiving, by the receiver of the processing server, the one or more contextual rules associated with each of the at least one payment cryptograms.

16. The system of claim 9, wherein
each of the one or more contextual rules specifies a threshold or limitation on one or more transaction data values, and
the determined approval or denial of the proposed payment transaction is further based on a value for each of the one or more transaction data values specified by each of the one or more contextual rules included in the transaction data as compared to the respective threshold or limitation.
